(19) United States
(12) Patent Application Publication
(10) Pub. No.: US 2015/0241623 A1
(43) Pub. Date: Aug. 27, 2015

(54) DEVICE AND METHOD FOR PRODUCING LIGHT GUIDE PLATE

(71) Applicant: MUTOH INDUSTRIES LTD., Tokyo (JP)

(72) Inventors: Yoichi Abe, Tokyo (JP); Tomoo Nakajima, Tokyo (JP)

(21) Appl. No.: 14/427,133

(22) PCT Filed: Sep. 9, 2013
(86) PCT No.: PCT/JP2013/074182

§ 371 Date: Mar. 10, 2015

(30) Foreign Application Priority Data
Sep. 20, 2012 (JP) 2012-206624

(51) Int. Cl. F21V 8/00

(52) U.S. Cl. CPC G02B 6/0065

(57) ABSTRACT

A device is provided that can accurately prepare a light guide plate having a desired color temperature and a color. An inkjet printer includes a white ink supply section in which white ink including coloring pigment-base particles is stored in an ink container, the recording head of the inkjet printer is connected to the ink container so that the recording head can discharge white ink, the white ink is adjusted so that the contained amount of the coloring pigment-base particles of copper phthalocyanine included therein is adjusted depending on a desired color temperature of the light guide plate, white ink for which the contained amount of the copper phthalocyanine is adjusted is used by the inkjet printer to form a reflection printing on the light guide plate, thereby preparing a light guide plate including the color temperature corresponding to the white ink.

### TECHNICAL FIELD

The present invention relates to a method and a device for preparing a light guide plate in which light having entered through a side face is diffused and uniform light is generated at the surface.

### BACKGROUND ART

A method has been conventionally known to manufacture a light guide plate by setting a front face as an illuminating light illumination face and by forming a reflection printing face on a back face by many printing dots only by white ink color by an inkjet printer (see Patent Publication 1 for example).

### PRIOR ART PUBLICATION

### Patent Publication

Patent Publication 1: Japanese Patent Laid-Open Publication No. H9-68614

### SUMMARY OF THE INVENTION

### Problem to be Solved by the Invention

A light guide plate in which a reflection printing face is formed by white ink on a back face by an inkjet printer is used for various applications such as illumination or back lighting. In this type of light guide plate, the light-emitting face has a color temperature determined by the light source or white ink components for example. When the light guide plate requires a specific color temperature, it has been not easy to set the color temperature of the light guide plate to a desired color temperature and to provide a desired color.

The present invention has an objective of solving the above disadvantage.

### Means for Solving the Problem

In order to achieve the above objective, the present invention provides a method of preparing a light guide plate by transferring printing data of a light reflection pattern stored in a computer to an inkjet printer and the inkjet printer is used to subject the printing face of the light guide plate to a reflection printing for causing irregular reflection of light emitted to the interior of the light guide plate from the light source. The method is characterized in that the inkjet printer includes a white ink supply section in which white ink including coloring pigment-base particles is stored in an ink container. The recording head of the inkjet printer is connected to the ink container so that the recording head can discharge white ink. The white ink is adjusted so that the contained amount of the coloring pigment-base particles included therein is adjusted depending on a desired color temperature of the light guide plate. White ink for which the contained amount of the coloring pigment-base particles is adjusted is used by the inkjet printer to form a reflection printing on the light guide plate, thereby preparing a light guide plate including the color temperature corresponding to the white ink.

The present invention provides a method of preparing a light guide plate by transferring printing data of a light reflection pattern stored in a computer to an inkjet printer and the inkjet printer is used to subject the printing face of the light guide plate to a reflection printing for causing irregular reflection of light emitted to the interior of the light guide plate from the light source. The method is characterized in that the inkjet printer includes a white ink supply section in which white ink including coloring pigment-base particles is stored in an ink container. The recording head of the inkjet printer is connected to the ink container so that the recording head can discharge white ink. The white ink is adjusted so that the particle size of oxidized titanium and the contained amount of the coloring pigment-base particles included therein are adjusted depending on a desired color temperature of the light guide plate. White ink for which the particle size of oxidized titanium and the contained amount of the coloring pigment-base particles are adjusted is used by the inkjet printer to form a reflection printing on the light guide plate, thereby preparing a light guide plate including the color temperature corresponding to the white ink.

The present invention is characterized in that the coloring pigment-base particles is copper phthalocyanine.

The present invention is characterized in providing a device consisting of an inkjet printer and a computer for transferring to the printer printing data of a light reflection pattern, the device prepares a light guide plate by transferring printing data of a light reflection pattern stored in the computer to the inkjet printer and the inkjet printer is used to subject the printing face of the light guide plate to a reflection printing for causing irregular reflection of light emitted to the interior of the light guide plate from the light source. The inkjet printer includes a white ink supply section in which white ink including coloring pigment-base particles is stored in an ink container. The recording head of the inkjet printer is connected to the ink container so that the recording head can discharge white ink. The white ink is adjusted so that the contained amount of the coloring pigment-base particles included therein is adjusted depending on a desired color temperature of the light guide plate. White ink for which the contained amount of the coloring pigment-base particles is adjusted is used by the inkjet printer to form a reflection printing on the light guide plate, thereby preparing a light guide plate including the color temperature corresponding to the white ink.

The present invention is characterized in providing a device consisting of an inkjet printer and a computer for transferring to the printer printing data of a light reflection pattern, the device prepares a light guide plate by transferring printing data of a light reflection pattern stored in the computer to the inkjet printer and the inkjet printer is used to subject the printing face of the light guide plate to a reflection printing for causing irregular reflection of light emitted to the interior of the light guide plate from the light source. The method is characterized in that the inkjet printer includes a white ink supply section in which white ink including coloring pigment-base particles is stored in an ink container. The recording head of the inkjet printer is connected to the ink container so that the recording head can discharge white ink. The white ink is adjusted so that the particle size of oxidized titanium and the contained amount of the coloring pigment-base particles included therein are adjusted depending on a desired color temperature of the light guide plate. White ink for which which the particle size of oxidized titanium and the contained amount of the coloring pigment-base particles are adjusted is used by the inkjet printer to forma reflection printing on the light guide plate, thereby preparing a light guide plate including the color temperature corresponding to the white ink.

### Effect of the Invention

According to the present invention, a light guide plate can be accurately prepared that has desired color temperature and color. Furthermore, by adding coloring pigments (e.g., cyan, magenta, yellow) to white ink, the color temperature and color also can be significantly changed.

### BRIEF DESCRIPTION OF THE INVENTION

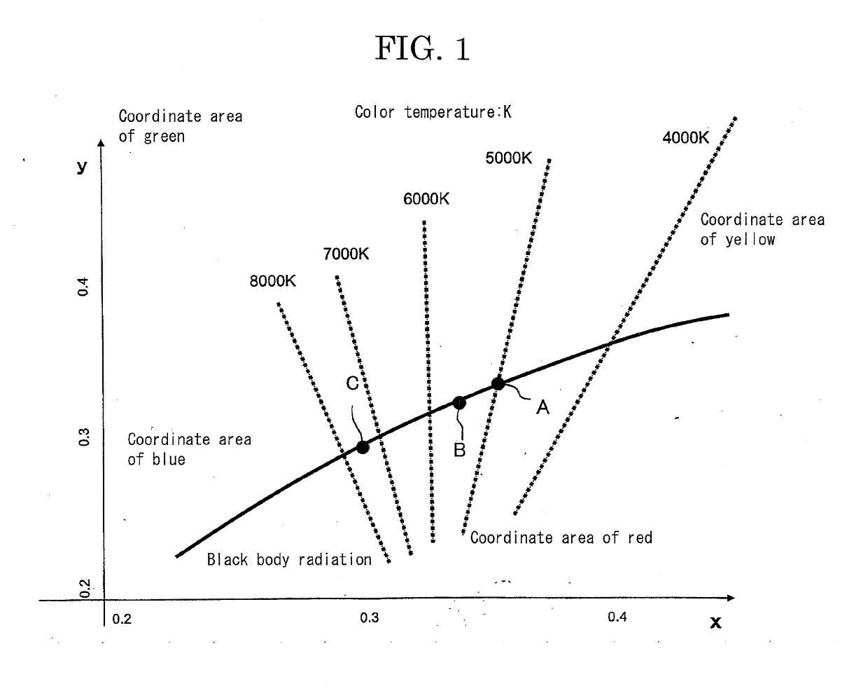

FIG. 1 is an illustration diagram of the present invention.

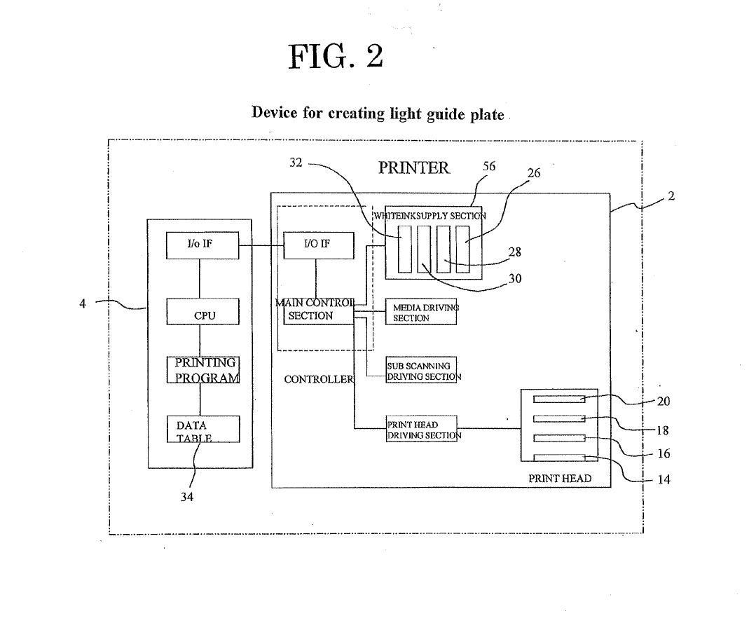

FIG. 2 is a block diagram of this device.

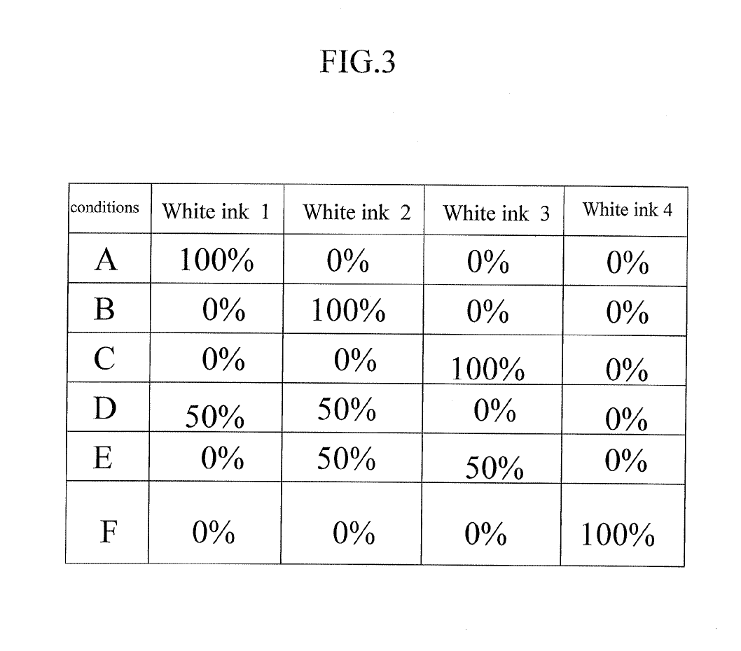

FIG. 3 is an illustration diagram of a data table.

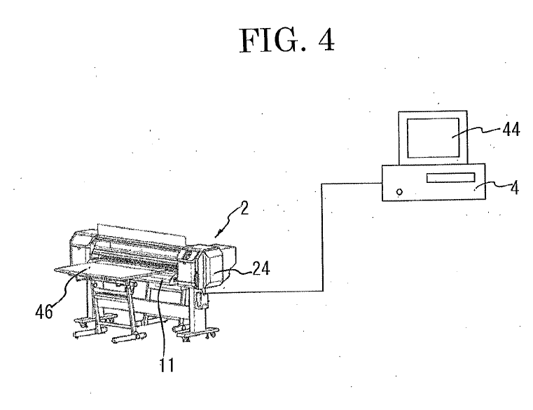

FIG. 4 is an illustration diagram of the present invention.

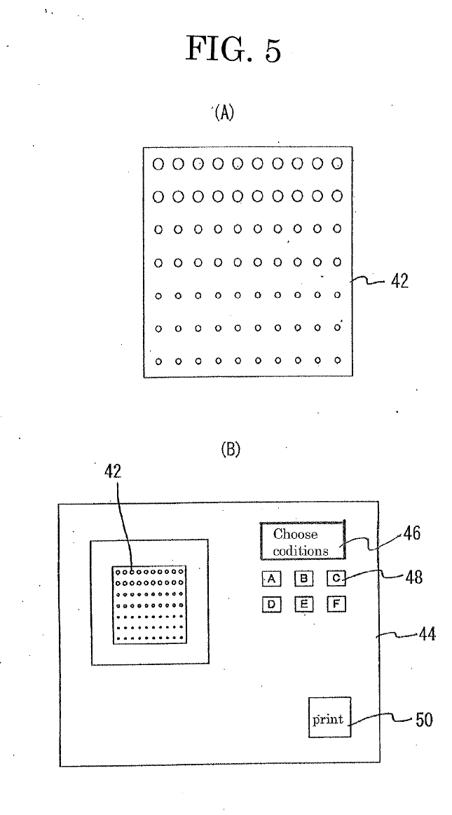

FIG. 5 is an illustration diagram of the present invention.

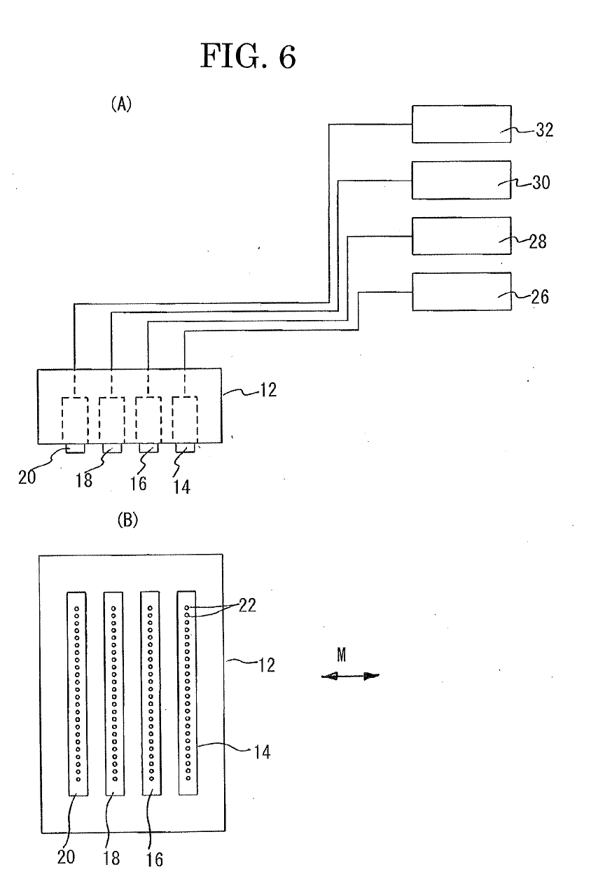

FIG. 6 is an illustration diagram of the present invention.

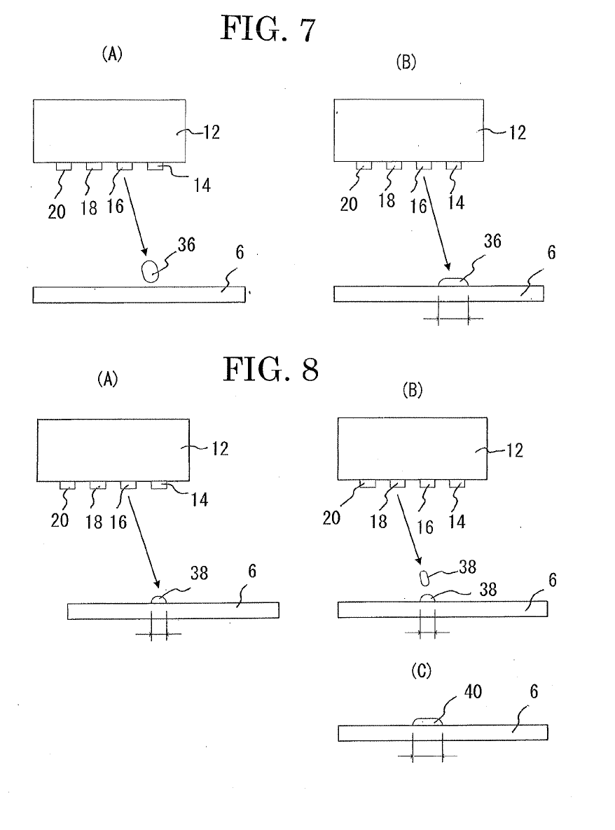

FIG. 7 is an illustration diagram of the present invention.

FIG. 8 is an illustration diagram of the present invention.

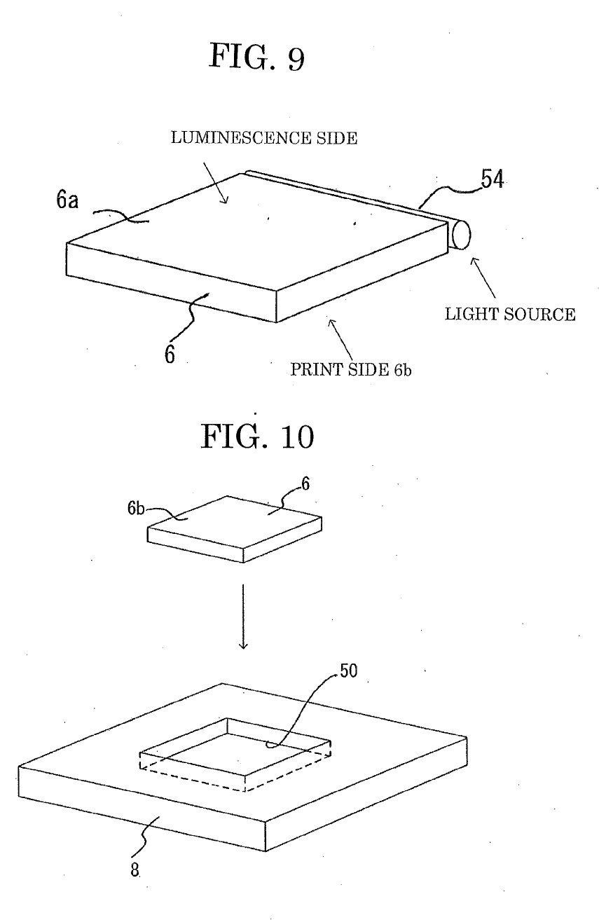

FIG. 9 is an illustration diagram of a light guide plate.

FIG. 10 is an illustration diagram of the present invention.

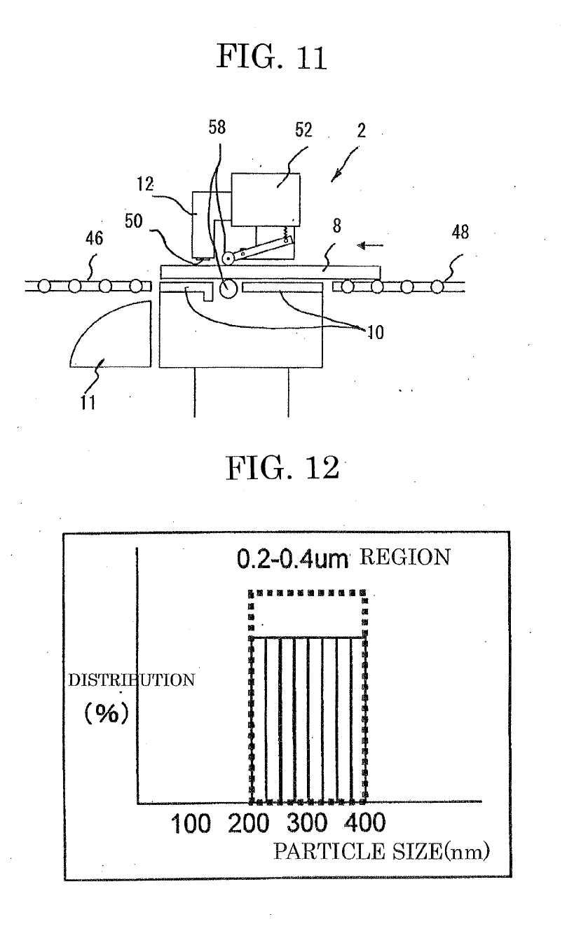

FIG. 11 is an illustration diagram of a printer.

FIG. 12 is an illustration diagram of the present invention.

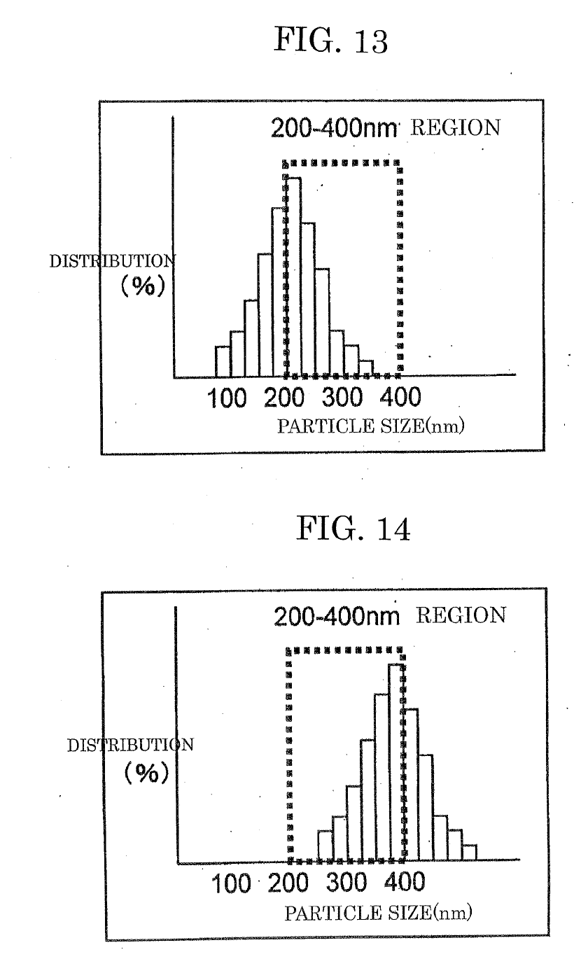

FIG. 13 is an illustration diagram of the present invention.

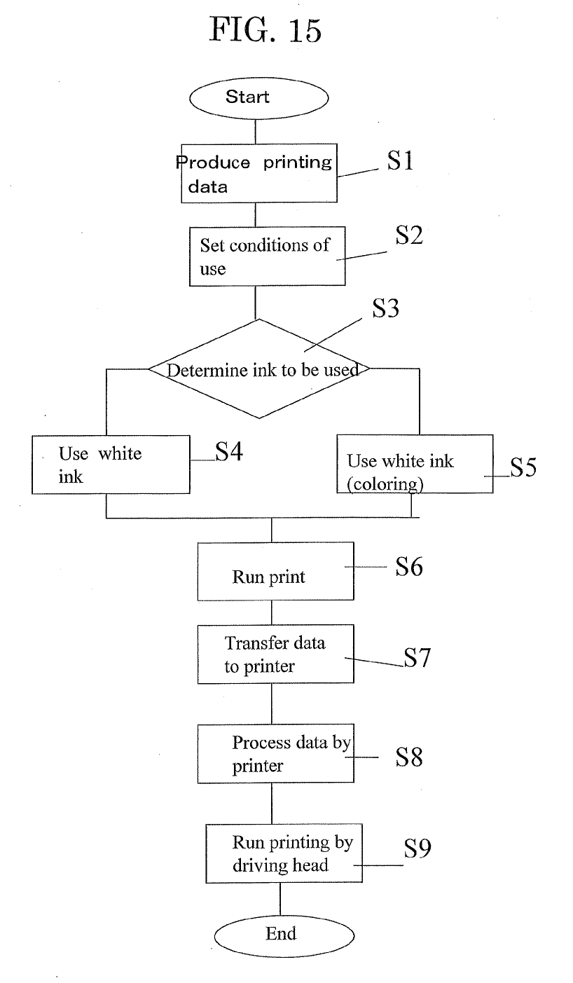

FIG. 14 is an illustration diagram of the present invention.

FIG. 15 is a flowchart illustrating the operation of the present invention.

### EMBODIMENT FOR CARRYING OUT THE INVENTION

The following section will describe in detail the configuration of the present invention with reference to the attached drawings.

FIGS. 2 and 4 are a schematic view illustrating a light guide plate printing device consisting of an inkjet printer 2 and a computer 4 (e.g., a personal computer) connected to the controller of the printer 2 via an input/output interface. As shown in FIG. 9, a light guide plate 6 is transported to a platen 10 from a transportation table 48 side by a medium driving mechanism 58 shown in FIG. 11 while being retained by an engagement concave section 50 of a board-like transportation assistance member 8 so that the back-side printing face 6b faces upward to the light-emitting face 6a. With regard to the light guide plate 6 on the platen 10, a printing section 50 including an inkjet recording head is moved in a main scanning direction orthogonal to the transportation direction while discharging ink through nozzles. The printing data transferred from the computer 4 to the controller of the inkjet printer 2 is printed on the printing face 6b of the light guide plate 6 by the control by software stored in the controller. The light guide plate 6 for which printing is completed is transported onto a transportation table 46 provided on a guide 11.

The platen 10 has thereon a lateral rail 52. The lateral rail 52 is connected to a carriage 12 in a movable manner. This carriage 12 retains, as shown in FIG. 6, a plurality of inkjet recording heads 14, 16, 18, and 20. The respective recording heads 14, 16, 18, and 20 include many nozzles 22 through which ink is discharged. The respective heads 14, 16, 18, and 20 communicate, as shown in FIG. 6(A), with the respective ink containers 26, 28, 30, and 32 included in a white ink supply section 56 provided on a body 24 of the printer 2 via an ink supply means such as a tube.

The plurality of recording heads 14, 16, 18, and 20 are parallelly arranged, as shown in FIG. 6(B), so that the printing regions are mutually superposed in the main scanning direction M along the lateral rail 52. The storage device of the computer 4 stores therein software (printing program) for preparing printing data of a light reflection pattern. The storage device includes a data table 34 shown in FIG. 3. This data table 34 includes combinations of color temperatures and inks set in advance so that light guide plates having many color temperatures can be prepared by using or combining each or a plurality of types of white inks to print a light guide plate. This data table 34 can be used to easily prepare light guide plates having many color temperatures. The printing control software stored in the computer can provide the preparation and correction of the data table 34 for example.

The prepared light guide plate 6 is, as shown in FIG. 9, obtained by printing reflection dots or a reflection gradation (fine dots like those of fogged glass) on a flat surface of the printing face 6b of a transparent acrylic plate. The light guide plate 6 functions to provide a situation as if light is emitted from the entire flat surface of the light-emitting face 6a by providing a light source 54 consisting of a light-emitting structure (e.g., a cold-cathode tube or an LED) at the thickness part of the light guide plate 6.

The data table 34 shows a case where three types of white inks 1, 2, and 3 having different color temperatures and white ink 4 (coloring) are prepared. When ink using oxidized titanium is used, white inks 1, 2, and 3 having different color temperatures depending on the particle size distribution of oxidized titanium in ink are prepared. When the dispersion of the particle size distribution is changed, a difference in reflection light is provided, causing a difference in a color temperature. A further change also can be provided by the use of the white ink 4 (coloring).

### Regarding White Ink and Color Temperature

White ink includes ink pigments of oxidized titanium. Oxidized titanium particles have a property according to which light having a wavelength two times longer than the particle size is reflected most strongly. Ideal white ink is configured so that oxidized titanium has a particle size distribution uniformly existing in a range from 200 nm to 400 nm as shown in FIG. 12. In such a case, such white color is obtained that uniformly reflects the light from 400 nm to 800 nm (visible light) having a wavelength two times larger than the particle size of 200 nm to 400 nm. However, in the case of actual white ink, it is rare for the particle size distribution to uniformly exist in a range of 200 nm to 400 nm.

(1) When the most particle size distribution exists at 200 nm (see FIG. 13), white ink strongly reflecting 400 nm light (short wavelength) or blueish white ink having a high color temperature is obtained.

(2) When the most particle size distribution exists at a particle size of 400 nm (see FIG. 14), white ink strongly reflecting 800 nm light (long wavelength) or reddish, yellowish, or greenish white ink having a low color temperature is obtained.

In the color temperature adjustment, these combinations of white inks having different color temperatures (or different oxidized titanium distributions) are used to prepare a light guide plate having a desired color temperature=a desired oxidized titanium distribution=a desired light wavelength region.

FIG. 12 to FIG. 14 illustrate the distribution image of the particle size of oxidized titanium in the ink in which the horizontal axis shows the particle diameter while the vertical axis shows the distribution level. FIG. 12 shows the distribution of oxidized titanium particles in ideal white ink. FIG. 13 to FIG. 14 show the distribution of oxidized titanium particles in an actual white ink. In FIG. 3, when assuming that the same light source is used and the light guide plate printed under the printing conditions A shown in FIG. 2 has a color temperature of 4500K, then the color temperature is 5000K when the light guide plate is printed under the conditions B and the color temperature is 5500K when the light guide plate is printed under the conditions C. By combining these results, the conditions D provide the color temperature of 4500K to 5000K and the conditions E provide the color temperature of 5000K to 5500K.

The invention is not limited to FIGS. 13-14. Specifically, a certain particle size may be set to 50% or 90% for example. FIG. 5 shows the light reflection pattern of the light guide plate in which uniform reflection is provided so that the light reflection pattern has an area increasing while being farther away from the light source. The pattern may be obtained, in addition to by being provided by an increased area, by being printed with areas having an increased density or by using the combinations thereof. Alternatively, gradation pattern may be be printed by a very high resolution printing mode.

FIGS. 7 and 8 are an illustration diagram of the printing operation of the inkjet recording head. The recording head 14 communicates with the ink container 26 including the white ink 1 provided in the data table 34. The recording head 16 communicates with the ink container 28 including the white ink 2. The recording head 18 communicates with the ink container 30 including the white ink 3. The recording head 20 communicates with the ink container 32 including the white ink 4. The white inks 1, 2, and 3 mutually have different particle size distribution of oxidized titanium in ink and thus have different ink color temperatures.

FIGS. 7(A) and 7(B) show the printing operation under the conditions B shown in the data table 34 of FIG. 3. In FIG. 7(A), a general amount of the ink dot 36 of the white ink 2 is discharged through the nozzle of the recording head 16. The ink dot 36 of 100% of the white ink 2 is formed on the light guide plate 6 in an amount corresponding to 1 dot. Specifically, only the white ink 2 is used for the printing of the entire face.

FIGS. 8(A), 8(B), and 8(C) show the printing operation under the conditions E shown in the data table 34 of FIG. 3. In FIGS. 8(A), 8(B), and 8(C), a half amount of the general amount of the ink dot 38 of the white ink 2 is discharged through the nozzle of the recording head 16 and is printed on the light guide plate 6. Next, the recording head 18 discharges a half amount of the general amount of the ink dot 38 of the white ink 3 onto the previously-printed ink dot 38 of the white ink 2. Then, the two ink dots 38 and 38 are printed in a superposed manner in an amount corresponding to 1 dot. The printing 40 corresponding to 1 dot through the superposed printing is composed of 50% of the white ink 2 and 50% of the white ink 3. Specifically, the white ink 2 and the white ink 3 are combined to print the entire face. This ink discharge control is printed by preparing a plurality of printing waveforms or driving voltages for driving the head and by selecting and using a required driving waveform or driving voltage.

In this embodiment, the to-be-used white ink 4 is added with a small amount of cyan pigments (copper phthalocyanine) or other coloring pigments in order to adjust the ink color temperature. This consequently provides not only a desired color temperature but also a desired color (i.e., a desired light wavelength). An appropriate addition amount of copper phthalocyanine or other pigments is experimentally selected by referring to the graph of the shift of the color coordinate by the ink shown in FIG. 1 to thereby control the ink color temperature. In FIG. 1, A shows the color coordinate of the light guide plate prepared by ink of oxidized titanium having an average particle diameter of 300 nm. B shows the color coordinate of the light guide plate prepared by ink of oxidized titanium having an average particle diameter of 200 nm. C shows the color coordinate of the light guide plate prepared by ink of oxidized titanium having an average particle diameter of 300 nm mixed with blue (cyan) pigments. A plurality of the white inks 4 may be prepared by having different average oxidized titanium particle sizes or by having different addition ratios of cyan pigments (copper phthalocyanine), or by having different colors (e.g., cyan, magenta, or yellow).

The shift of the light guide plate color temperature of the gradation due to the difference in the average oxidized titanium particle size is about 400K and no substantial change is caused in brightness. In FIG. 1, A is on black-body radiation but may be dislocated. This depends on the color coordinate of the LED as a light source. A direction along which the color coordinate shifts due to the particle size or pigments is the same. The shift of the color coordinate due to cyan pigments (copper phthalocyanine) depends on the ratio of pigments. Even a ratio of about 1% may cause a shift of about 1000K. The magnitude of the shift depends on the color coordinate of the LED as a light source. When the LED originally has a high color temperature (=blue), then the magnitude of the shift due to the particle size or pigments is smaller. A larger shift causes a lower brightness.

Next, with reference to the flowchart of FIG. 15, a step will be described to subject the printing face of the light guide plate to a reflection printing.

First, an operator in Step 1 uses software for preparing a reflection pattern of a light guide plate to prepare the reflection face printing data 42 on the computer 4. This printing data 42 is displayed on a display 44 of the computer 4. This display 44 displays a data input display 48 showing white ink use conditions A, B, C, D, E, and F. The use conditions A, B, C, D, E, and F on the display 48 correspond to the data table 34.

Next, the operator in Step 2 refers to the display 48 of the display 44 of the computer 4 to select use conditions and uses an input means such as a mouse to click a condition selection button display 46 to input use conditions (i.e., printing conditions) to the computer 4. Based on the selected conditions, the computer refers to the data table 34 to determine to-be-used inks 1, 2, 3 and 4 in Step 3. The computer 4 in Step 4 selects a mode for using the white ink 1, 2, and 3 or the computer 4 in Step 5 selects a mode for using the white ink 4 (coloring). When a printing button 50 is executed through the computer 4 in Step 6, the printing data is transferred from the computer 4 to the printer 2 (Step 7). Thereafter, after the data is processed by the printer 2 (Step 8), the recording head is driven in the main scanning direction and the white ink or white ink 4 (coloring) is printed on the light guide plate 6 under the selected printing conditions (Step 9).

The data table 34 may be provided in a memory included in the controller of the printer 2. In this case, the printing conditions may be firstly set by the printer 2 so that only the printing data can be sent from the computer 4.

The above embodiment has been described with a structure in which recording heads are parallelly arranged in a serial printer for moving the recording head in the main scanning direction. However, the recording heads also may be arranged in a longitudinal direction of a nozzle column. Another structure also may be used in which line heads longer than the width of the light guide plate are used and are arranged in a direction orthogonal to the transportation direction of the light guide plate. The printer also may have a structure in which the light guide plate is fixed on the platen and the recording head is moved. In this embodiment, the respective plurality of types of white inks are stored in ink containers. However, the invention is not limited to this. Another structure also may be used in which one type of white ink 4 is stored in an ink container.

### DESCRIPTION OF REFERENCE NUMERALS

2 Inkjet printer
4 Computer
6 Light guide plate
8 Transportation assistance member
10 Platen
12 Carriage
14 Recording head
16 Recording head
18 Recording head
20 Recording head
22 Nozzle
24 Body
26 Ink container
28 Ink container
30 Ink container
32 Ink container
34 Data table
36 Ink dots
38 Ink dots
40 Ink dots
42 Printing data
44 Display
46 Transportation table
48 Transportation table
50 Printing section
52 Lateral rail
54 Light source
56 White ink supply section
58 Medium driving mechanism

1. A method of preparing a light guide plate by transferring printing data of a light reflection pattern stored in a computer to an inkjet printer and the inkjet printer is used to subject the printing face of the light guide plate to a reflection printing for causing irregular reflection of light emitted to the interior of the light guide plate from the light source, wherein the inkjet printer includes a white ink supply section in which white ink including coloring pigment-base particles is stored in an ink container, the recording head of the inkjet printer is connected to the ink container so that the recording head can discharge white ink, the white ink is adjusted so that the contained amount of the coloring pigment-base particles included therein is adjusted depending on a desired color temperature of the light guide plate, white ink for which the contained amount of the coloring pigment-base particles is adjusted is used by the inkjet printer to form a reflection printing on the light guide plate, thereby preparing a light guide plate including the color temperature corresponding to the white ink.

2. A method of preparing a light guide plate by transferring printing data of a light reflection pattern stored in a computer to an inkjet printer and the inkjet printer is used to subject the printing face of the light guide plate to a reflection printing for causing irregular reflection of light emitted to the interior of the light guide plate from the light source, wherein the inkjet printer includes a white ink supply section in which white ink including coloring pigment-base particles is stored in an ink container, the recording head of the inkjet printer is connected to the ink container so that the recording head can discharge white ink, the white ink is adjusted so that the particle size of oxidized titanium and the contained amount of the coloring pigment-base particles included therein are adjusted depending on the color temperature of a desired light guide plate, white ink for which the particle size of oxidized titanium and the contained amount of the coloring pigment-base particles are adjusted is used by the inkjet printer to form a reflection printing on the light guide plate, thereby preparing a light guide plate including the color temperature corresponding to the white ink.

3. The light guide plate preparation method according to claim 1, wherein the coloring pigment-base particle is copper phthalocyanine.

4. A device consisting of an inkjet printer and a computer for transferring to the printer printing data of a light reflection pattern for preparing a light guide plate by transferring printing data of a light reflection pattern stored in the computer to the inkjet printer to use the inkjet printer to subject the printing face of the light guide plate to a reflection printing for causing irregular reflection of light emitted to the interior of the light guide plate from the light source, wherein the inkjet printer includes a white ink supply section in which white ink including coloring pigment-base particles is stored in an ink container, the recording head of the inkjet printer is connected to the ink container so that the recording head can discharge white ink, the white ink is adjusted so that the contained amount of the coloring pigment-base particles included therein is adjusted depending on a desired color temperature of the light guide plate, white ink for which the contained amount of the coloring pigment-base particles is adjusted is used by the inkjet printer to form a reflection printing on the light guide plate, thereby preparing a light guide plate including the color temperature corresponding to the white ink.

5. A device consisting of an inkjet printer and a computer for transferring to the printer printing data of a light reflection pattern for preparing a light guide plate by transferring printing data of a light reflection pattern stored in the computer to the inkjet printer to use the inkjet printer to subject the printing face of the light guide plate to a reflection printing for causing irregular reflection of light emitted to the interior of the light guide plate from the light source, wherein the inkjet printer includes a white ink supply section in which white ink including coloring pigment-base particles is stored in an ink container, the recording head of the inkjet printer is connected to the ink container so that the recording head can discharge white ink, the white ink is adjusted so that the particle size of oxidized titanium and the contained amount of the coloring pigment-base particles included therein are adjusted depending on a desired color temperature of the light guide plate, white ink for which the particle size of oxidized titanium and the contained amount of the coloring pigment-base particles are adjusted is used by the inkjet printer to form a reflection printing on the light guide plate, thereby preparing a light guide plate including the color temperature corresponding to the white ink.

6. The light guide plate preparation device according to claim 4, wherein the coloring pigment-base particle is copper phthalocyanine.

7. The light guide plate preparation method according to claim 2, wherein the coloring pigment-base particle is copper phthalocyanine.

8. The light guide plate preparation device according to claim 5, wherein the coloring pigment-base particle is copper phthalocyanine.
